(19) United States
(12) Patent Application Publication
(10) Pub. No.: US 2011/0175848 A1
(43) Pub. Date: Jul. 21, 2011

(54) INFRARED RAY TOUCH PANEL DEVICE WITH HIGH EFFICIENCY

(76) Inventor: Yi-Huei Chen, Taipei County (TW)

(21) Appl. No.: 12/750,694

(22) Filed: Mar. 30, 2010

(30) Foreign Application Priority Data
Jan. 20, 2010 (CN) 201010002401.2

(51) Int. Cl. G06F 3/042

(52) U.S. Cl. 345/175

(57) ABSTRACT

An IR touch panel device includes a housing, a plurality of first IR receivers, a first IR transmitter, a plurality of second IR receivers and a second IR transmitter. The plurality of first IR receivers are installed on a bottom side of the housing; the first IR transmitter is installed on a top side of the housing, transmission range of the first IR transmitter covering the plurality of first IR receivers; the plurality of second IR receivers are installed on a right side of the housing; the second IR transmitter is installed on a left side of the housing, transmission range of the second IR transmitter covering the plurality of second IR receivers. A user may control operation of the IR touch panel device through blocking a path between the IR transmitter and the IR receiver.

### BACKGROUND OF THE INVENTION

1. Field of the Invention

The present invention relates to a touch panel device, and more particularly, to an infrared ray (IR) touch panel device.

2. Description of the Prior Art

Electronic products are shrinking in size and have large displays, but operation buttons in the electronic products are still necessary. Thus, demand for touch panels increases. An IR touch panel is one type of touch panel. IR touch components can be installed on a conventional non-touch panel, so as to enhance the conventional non-touch panel with touch functions; or, when producing a panel, IR touch components may be installed inside the panel directly.

IR touch technology is the most popular touch technology in existing large-size panels. The IR touch technology uses IR receivers and IR transmitters installed on opposite sides of a panel. When the IR receivers receive IR rays from the IR transmitters, the IR rays may form a crisscross IR net above the panel. If an object blocks at least one IR ray of the IR rays, a microcontroller connecting to the IR receivers and the IR transmitters determines a location of the object (that is a touch point) and transmits a digital signal to a processor, which may control the panel. Then, the panel may display the location of the object on the panel or may execute special functions according to the location of the object through software. IR touch technology uses a method of blocking an IR path between an IR receiver and an IR transmitter, so the IR touch panel has the advantage of high sensitivity without requiring the user to physically touch the materials of the panel. High hardness and high light transmittance materials (such as glass, acrylic, or plastic) may also be used to protect the panel from scratching, while maintaining the original color of the panel, preventing dust, and resisting electromagnetic interference.

Response speed of the IR touch panel depends on the main processing integrate circuit (IC), and resolution depends on density of IR transmitters and IR receivers. Designed properly, dimensions of the IR touch panel may easily reach 80-90 inches. An 80-90 inch IR touch panel may easily replace traditional blackboards and whiteboards. Therefore, when the IR touch panel is combined with proper software, the IR touch panel may be used as an electronic whiteboard in classroom and office environments, where the electronic whiteboard (the IR touch panel) can be used as an interactive screen in the above fields.

The IR touch panel uses the method of blocking an IR path to detect touch position, so the user does not need to touch the IR touch panel directly, and the main processing IC may control the operation of the IR touch panel. In the medical field, the touch panel must meet waterproof and dustproof requirements. When medical staff and patients splash fluid or contaminants on the touch panel, the touch panel cannot be cleaned easily. But if a mechanism of the touch panel is designed properly, the touch panel may be waterproof and dustproof. In addition, the touch panel with high sensitivity reduces the amount of effort required by patients or medical staff using the touch panel.

Large-size interactive advertising players with IR touch functions have characteristics of low cost and easy installation. Static advertisements such as video clips and Flash animations, may be displayed on 32-inch and 42-inch liquid crystal display screens in department stores, convenience stores, and large showrooms. By installing the IR touch components into large-size screens and adding proper advertisement content, such as Flash advertisements and web pages with menus, liquid crystal screens become interactive advertising players. Attraction and interactivity of the IR touch panel are better than in traditional static advertising players.

Please refer to FIG. 1. FIG. 1 is a diagram of an infrared (IR) touch panel including a plurality of IR transmitters and a plurality of IR receivers according to the prior art. As shown in FIG. 1, the plurality of IR transmitters and the plurality of IR receivers are installed around the IR touch panel to form an IR touch array, where there is a one-to-one relationship between the IR transmitters and the IR receivers. Thus, the IR touch panel in FIG. 1 requires a large number of LED transmitter modules and LED receiver modules. Please refer to FIG. 2. FIG. 2 is a diagram of a non-array IR touch panel including a plurality of IR transmitters and an IR receiver according to the prior art. The IR touch panel in FIG. 2 uses an IR receiver for receiving IR rays from the plurality of IR transmitters. The plurality of IR transmitters transmits IR rays to the IR receiver in turns, and then the microcontroller determines which IR path between the IR transmitter and the IR receiver is blocked. Please refer to FIG. 3. FIG. 3 is a diagram of a non-array IR touch panel including a plurality of IR receivers and an IR transmitter according to the prior art. The IR touch panel in FIG. 3 uses the plurality of IR receivers and an IR transmitter to form a plurality of IR paths between the plurality of IR receivers and an IR transmitter. The microcontroller determines which IR path between the IR transmitter and the IR receiver is blocked. Each IR path shown in FIG. 2 and FIG. 3 can only be assigned a single touch point, so the prior art in FIG. 2 and FIG. 3 are unable to make efficient use of the space of the touch panel.

### SUMMARY OF THE INVENTION

An embodiment of the present invention provides an infrared ray (IR) touch panel device. The IR touch panel comprises a panel, a housing, a plurality of first IR receivers, at least one first IR transmitter, a plurality of second IR receivers, at least one second IR transmitter, and a microcontroller. The housing is installed around the panel; the plurality of first IR receivers are installed on a bottom side of the housing; the first IR transmitter is installed a top side of the housing and transmission range of the first IR transmitter covers the plurality of first IR receivers; the plurality of second IR receivers are installed on a right side of the housing; the second IR transmitter is installed on a left side of the housing and transmission range of the second IR transmitter covers the plurality of second IR receivers; the microcontroller electrically connects to the plurality of first IR receivers and the plurality of second IR receivers for receiving detecting signals from the plurality of first IR receivers and the plurality of second IR receivers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an infrared ray (IR) touch panel including a plurality of IR transmitters and a plurality of IR receivers according to the prior art.

FIG. 2 is a diagram of a non-array IR touch panel including a plurality of IR transmitters and an IR receiver according to the prior art.

FIG. 3 is a diagram of a non-array IR touch panel including a plurality of IR receivers and an IR transmitter according to the prior art.

FIG. 4 is a diagram of a display panel capable of IR touch function according to a first embodiment of the present invention.

FIG. 5 is a diagram illustrating the electrically connecting method among the microcontroller, the processor, and the plurality of first IR receivers (Q1-QN) in FIG. 4.

FIG. 6 is a diagram of the structure of the IR receiver.

FIG. 7 is a flowchart of a method for an IR touch in FIG. 4.

FIG. 8, FIG. 9, and FIG. 10, are diagrams illustrating the operation of the display panel in FIG. 4.

FIG. 11 is a diagram of a display panel capable of IR touch function according to a second embodiment of the present invention.

FIG. 12 is a diagram of a display panel capable of IR touch function according to a third embodiment of the present invention.

FIG. 13 is a diagram of a display panel capable of IR touch function according to a fourth embodiment of the present invention.

FIG. 14 is a diagram of a display panel capable of IR touch function according to a fifth embodiment of the present invention.

### DETAILED DESCRIPTION

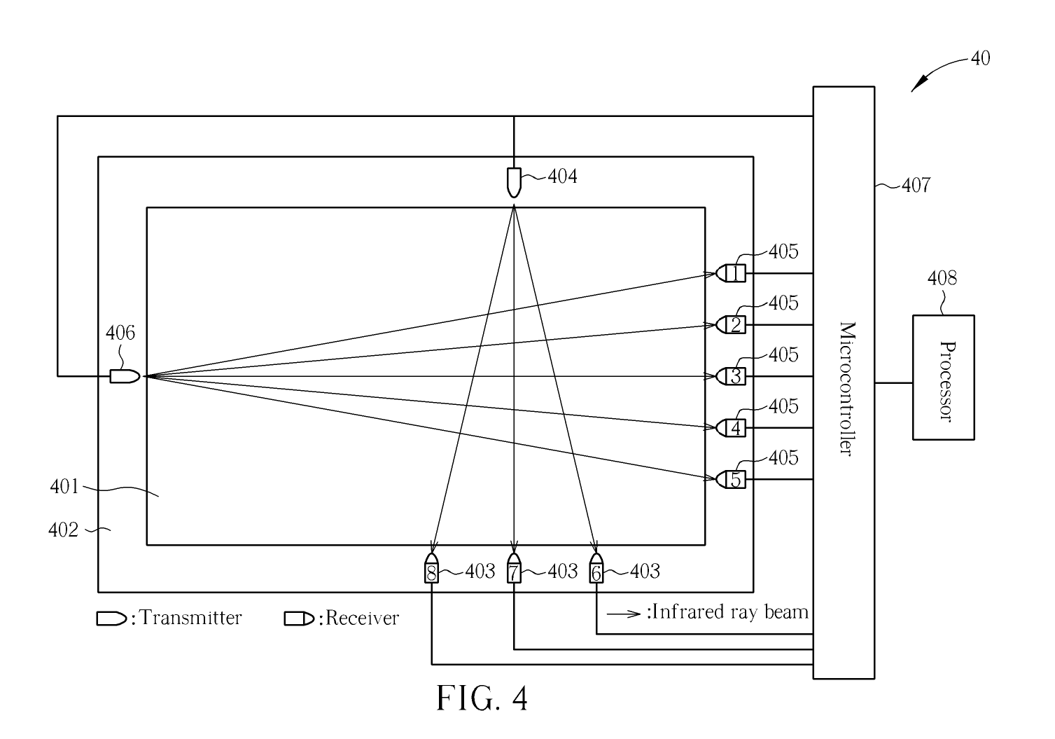

Please refer to FIG. 4. FIG. 4 is a diagram of a display panel 40 capable of IR touch functions according to a first embodiment of the present invention. The display panel 40 includes a panel 401, a housing 402, a plurality of first IR receivers 403, a first IR transmitter 404, a plurality of second IR receivers 405, a second IR transmitter 406, and a microcontroller 407. The housing 402 is installed around the panel 401. The plurality of first IR receivers 403 (number of the first IR receivers 403 is not limited to the first embodiment) are installed on a bottom side of the housing 402. The first IR transmitter 404 is installed at a top side of the housing 402, and transmission range of the first IR transmitter 404 covers the plurality of first IR receivers 403. The plurality of second IR receivers 405 (number of the second IR receivers 405 is not limited to the first embodiment) are installed on a right side of the housing 402. The second IR transmitter 406 is installed on a left side of the housing 402, and transmission range of the second IR transmitter 406 covers the plurality of second IR receivers 405. The microcontroller 407 may be electrically connected to the plurality of first IR receivers 403, the plurality of second IR receivers 405, the first IR transmitter 404, and the second IR transmitter 406 for receiving detection signals from the pluralities of IR receivers 403, 405. The first IR transmitter 404 and the second IR transmitter 406 may also be electrically connected to a switch of the display panel directly instead of being electrically connected to the microcontroller 407. A difference between the above two methods of electrically connecting the first IR transmitter 404 and the second IR transmitter 406 is that the former turns the first IR transmitter 404 and the second IR transmitter 406 on or off according to a controlling signal of the microcontroller 407, and the latter always turns on the first IR transmitter 404 and the second IR transmitter 406 once the display panel 40 is turned on. A processor 408 may be electrically connected to the microcontroller 407 for controlling operation of the display panel 40 according to a digital signal from the microcontroller 407.

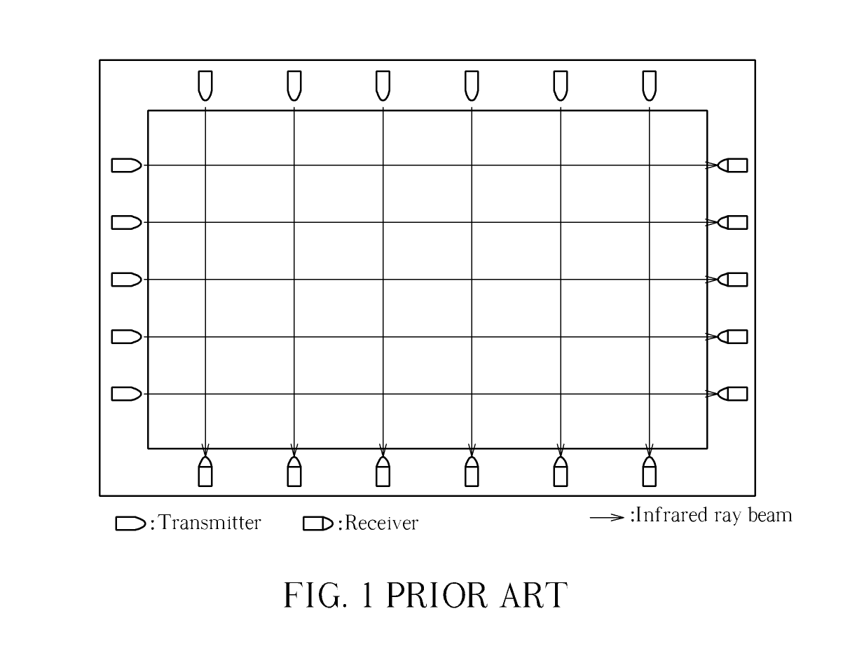

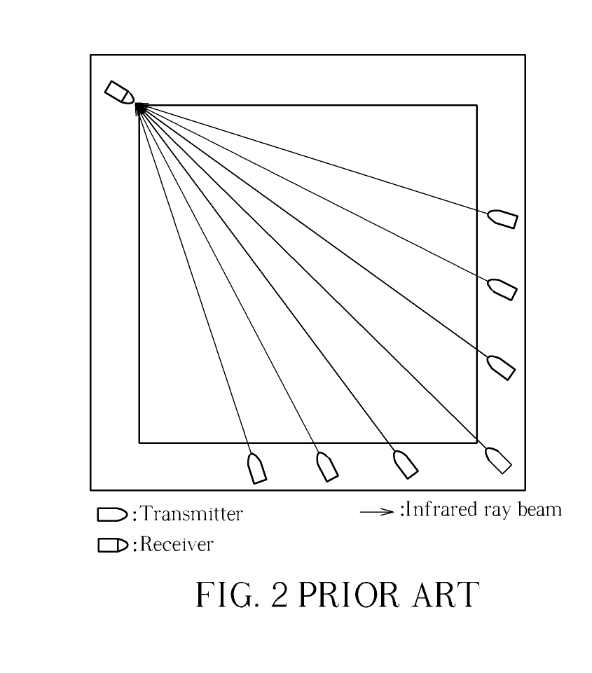

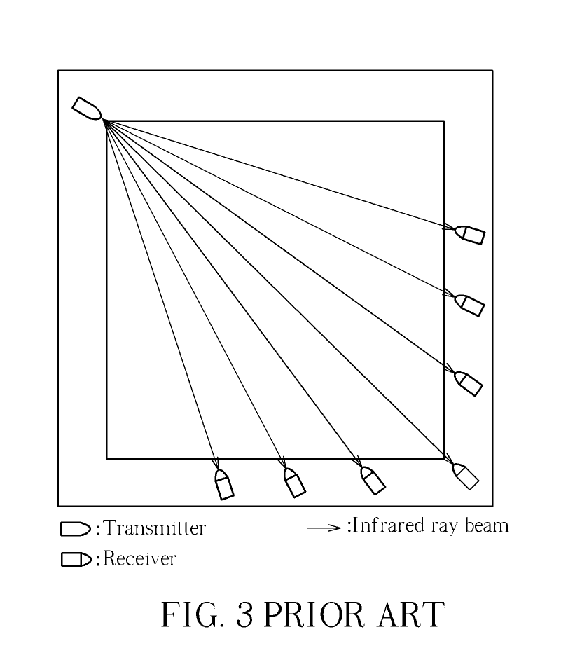

Please refer to FIG. 4. The first embodiment of the present invention is different from the IR touch panel in FIG. 1 in that each IR transmitter corresponds to a plurality of IR receivers. The first embodiment of the present invention has at least one IR transmitter corresponding to a plurality of IR receivers in the horizontal direction, and also in the vertical direction.

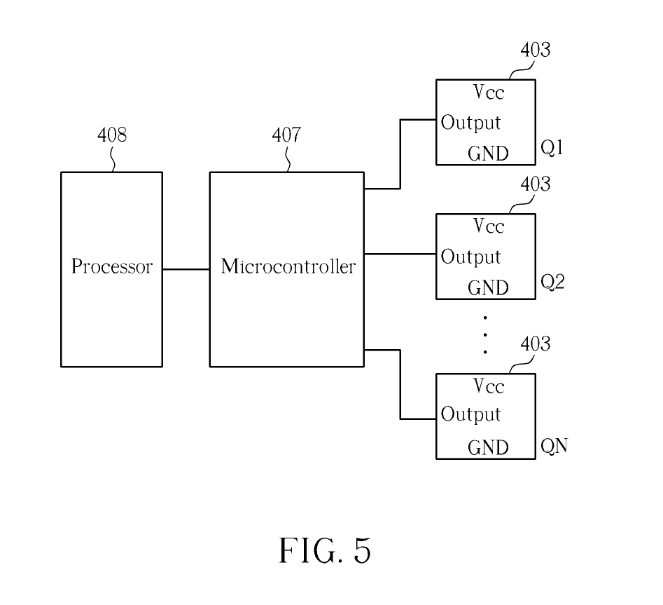

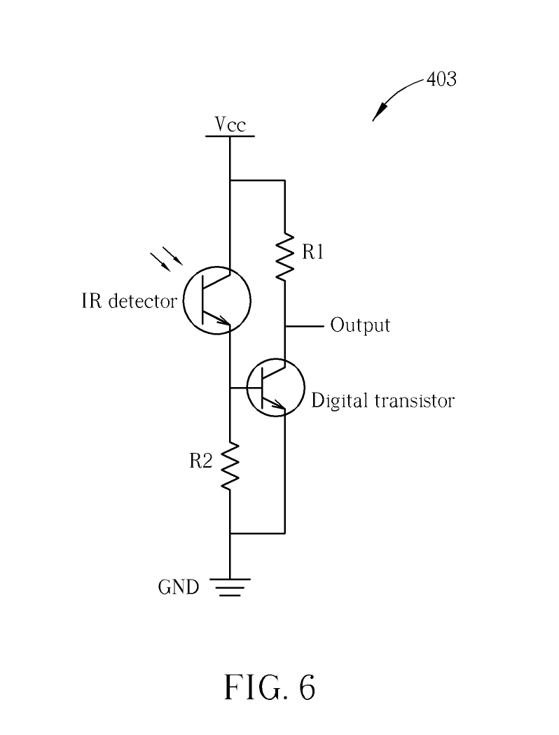

Please refer to FIG. 5. FIG. 5 is a diagram illustrating electrical connections between the microcontroller 407, the processor 408, and the plurality of first IR receivers 403 (Q1-QN) in FIG. 4. Electrical connections between the microcontroller 407, the processor 408, and the plurality of second IR receivers 405 are the same as in FIG. 5. Please refer to FIG. 6. FIG. 6 is a diagram of structure of the first IR receiver 403. The first IR receiver 403 includes a resistor R1, a resistor R2, an IR detector, and a digital transistor. When the first IR receiver 403 receives infrared rays, an output terminal of the first IR receiver 403 outputs a logic-low voltage 0; when the first IR receiver 403 does not receive infrared rays, the output terminal of the first IR receiver 403 outputs a logic-high voltage 1. Therefore, the microcontroller 407 can detect signal variations of N first IR receivers 403, and the processor 408 controls operation of the display panel 40 according to the digital signal from the microcontroller 407.

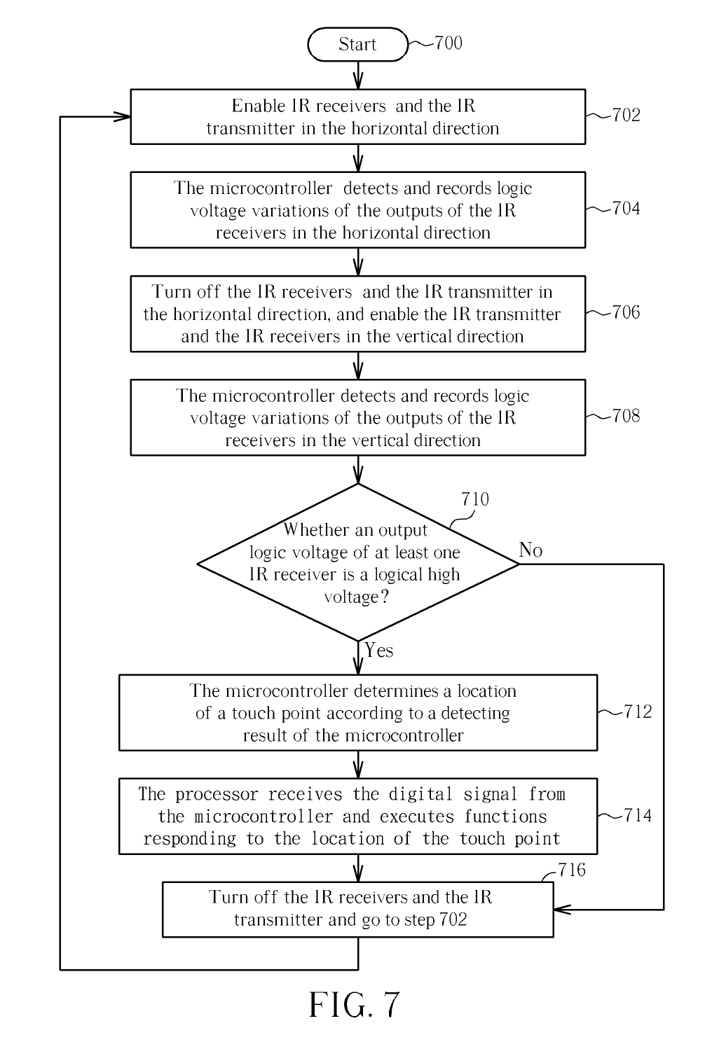

Please refer to FIG. 7. FIG. 7 is a flowchart of a method for the display panel 40. In Step 700, the display panel 40 is turned on. In Step 702, the plurality of second IR receivers 405 and the second IR transmitter 406 are enabled. Then, in Step 704, the microcontroller 407 detects and records logic voltage variations of the outputs of the plurality of second IR receivers 405. In Step 706, the plurality of second IR receivers 405 and the second IR transmitter 406 are turned off, and the first IR transmitter 404 and the plurality of first IR receivers 403 are enabled. Then in Step 708, the microcontroller 407 detects and records logic voltage variations of the outputs of the plurality of second IR receivers 403. In Step 710, the microcontroller 407 determines whether an output logic voltage of at least one IR receiver is a logical high voltage. If yes, the method proceeds to Step 712; if not, the method proceeds to Step 716. In Step 712, the microcontroller 407 determines a location of a touch point according to a detecting result of the microcontroller 407. In Step 714, the processor 408 receives the digital signal from the microcontroller 407 and executes functions corresponding to the location of the touch point. In Step 716, the plurality of first IR receivers 403 and the first IR transmitter 404 are turned off, and the method returns to Step 702.

The detecting method in FIG. 7 first enables the plurality of second IR receivers 405 and the second IR transmitter 406 in the horizontal direction, then enables the first IR transmitter 404 and the plurality of first IR receivers 403 in the vertical direction in turn. No limitation to the above method is made, and the method may also enable IR elements in the vertical direction, then enable IR elements in the horizontal direction in turn. In addition, if IR rays from the first IR transmitter 404 and the second IR transmitter 406 cannot interfere with each other, the first IR transmitter 404, the plurality of first IR receivers 403, the second IR transmitter 406, and the plurality of second IR receivers 405 may continue to be enabled any time.

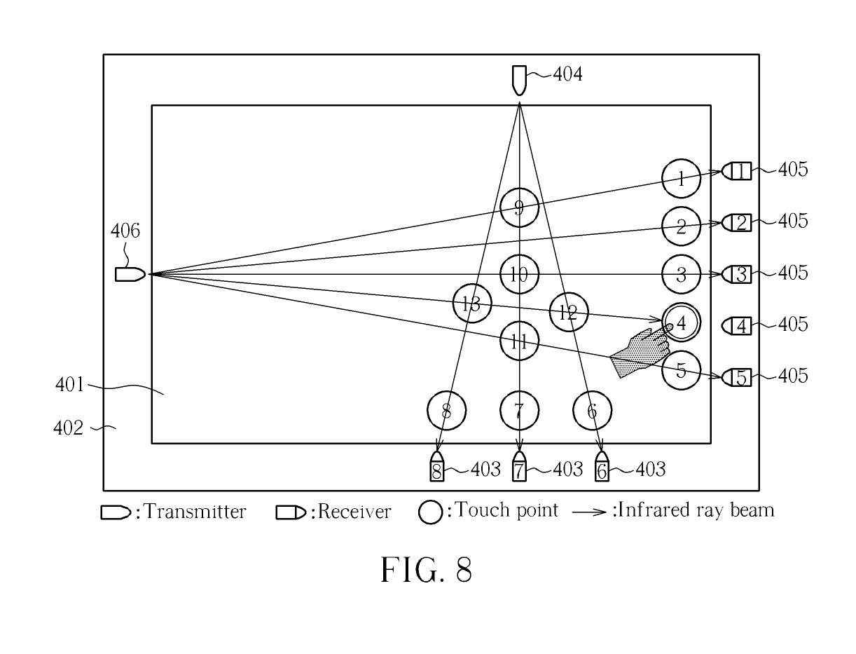

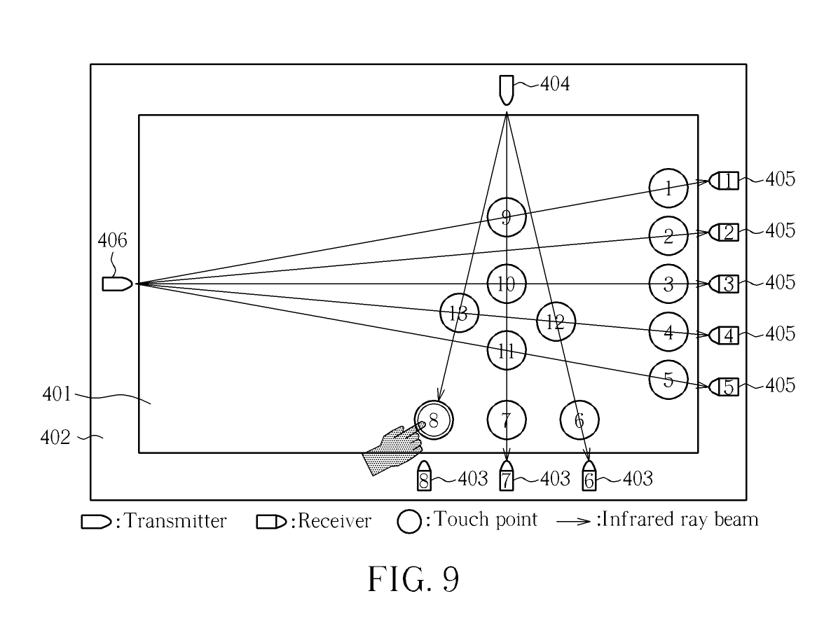

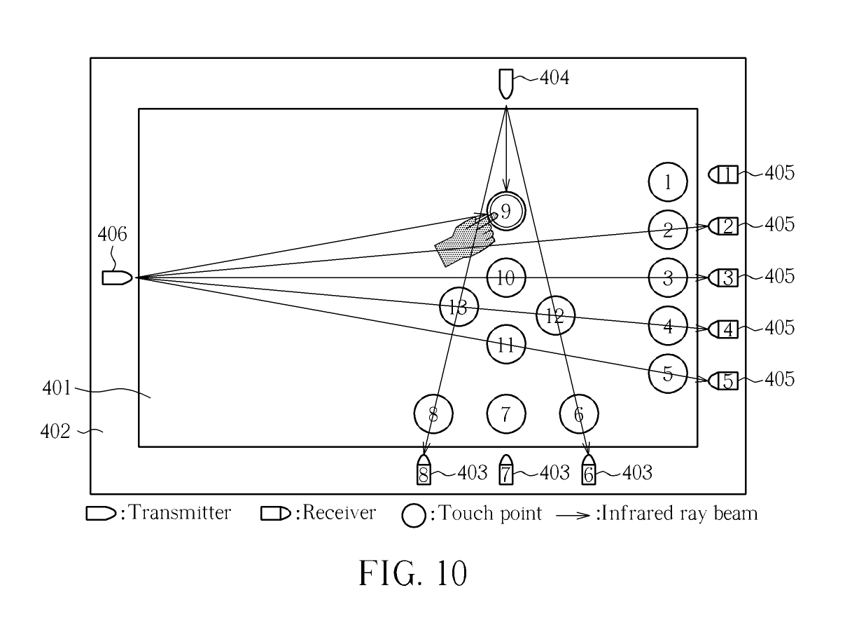

Please refer to FIG. 8, FIG. 9, and FIG. 10. FIG. 8, FIG. 9, and FIG. 10 are diagrams illustrating operation of the display panel 40. Similar reference numerals of the devices in FIG. 8, FIG. 9, and FIG. 10 indicate components similar to those in FIG. 4. In FIG. 8, FIG. 9, and FIG. 10, the display panel 40 has thirteen touch points.

In the display panel 40, touch points 1, 2, 3, 4, and 5 are only covered by the IR rays emitted by the second IR transmitter 406. Please refer to FIG. 8. When an object touches one of the touch points 1, 2, 3, 4, and 5, such as the touch point 4, the horizontal IR ray passing through the touch point 4 is blocked. Then, the microcontroller 407 determines the touch point 4 is triggered, and transmits a digital signal to the processor 408. The processor 408 executes functions according to the location of the touch point 4.

In the display panel 40, touch points 6, 7, and 8 are only covered by the IR rays emitted by the first IR transmitter 404. Please refer to FIG. 9. When an object touches one of the touch points 6, 7, and 8, such as the touch point 8, the vertical IR ray passing through the touch point 8 is blocked. Then, the microcontroller 407 determines that the touch point 8 is triggered, and transmits a digital signal to the processor 408. The processor 408 executes functions according to the location of the touch point 8.

In the display panel 40, touch points 9, 10, 11, 12, and 13 are covered by both the IR rays emitted by the first IR transmitter 404 and the IR rays emitted by the second IR transmitter 406 at the same time. Please refer to FIG. 10. When an object touches one of the touch points 9, 10, 11, 12, and 13, such as the touch point 9, the horizontal IR ray and the vertical IR ray passing through the touch point 9 are blocked at the same time. Then, the microcontroller 407 determines the touch point 9 is triggered, and transmits a digital signal to the processor 408. The processor 408 executes functions according to the location of the touch point 9.

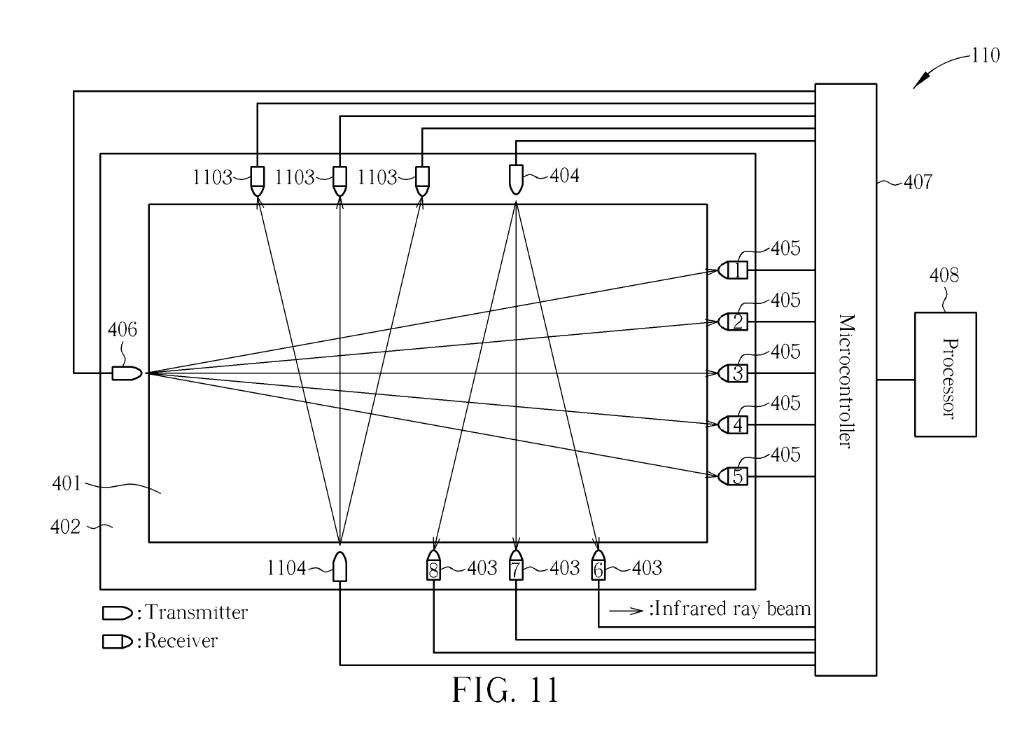

Please refer to FIG. 11. FIG. 11 is a diagram of a display panel 110 capable of IR touch functions according to a second embodiment of the present invention. A difference between the display panel 110 and the display panel 40 is that the display panel 110 further includes a plurality of third IR receivers 1103 and a third IR transmitter 1104. The plurality of third IR receivers 1103 are installed on the top side of the housing 402 and are electrically connected to the microcontroller 407. The third IR transmitter 1104 is installed at the bottom side of the housing 402, and transmission range of the third IR transmitter 1104 covers the plurality of third IR receivers 1103. As shown in FIG. 11, the display panel 110 has more touch points than the display panel 40. In addition, electrical connections between the microcontroller 407, the processor 408, and the plurality of third receivers 1103 are the same as shown in FIG. 5.

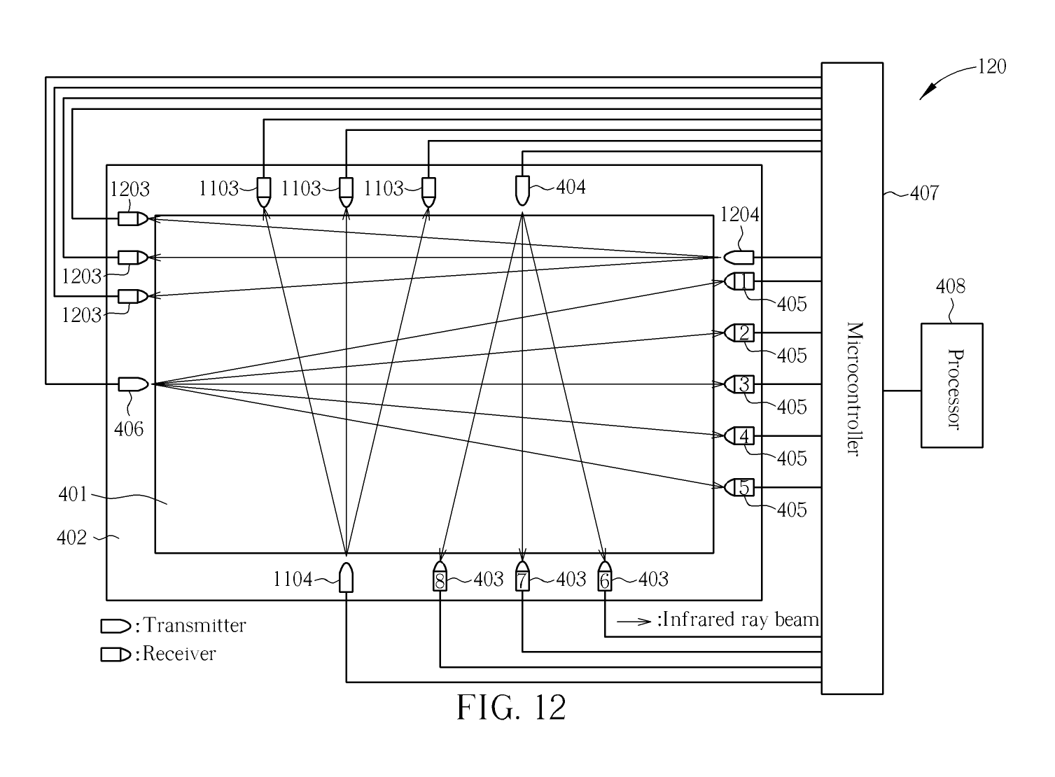

Please refer to FIG. 12. FIG. 12 is a diagram of a display panel 120 capable of IR touch functions according to a third embodiment of the present invention. A difference between the display panel 120 and the display panel 110 is that the display panel 120 further includes a plurality of fourth IR receivers 1203 and a fourth IR transmitter 1204. The plurality of fourth IR receivers 1203 are installed on the left side of the housing 402 and are electrically connected to the microcontroller 407. The fourth IR transmitter 1204 is installed on the right side of the housing 402, and transmission range of the fourth IR transmitter 1204 covers the plurality of fourth IR receivers 1203. As shown in FIG. 12, the display panel 120 has more touch points than the display panel 110. In addition, electrical connections between the microcontroller 407, the processor 408, and the plurality of fourth IR receivers 1203 are the same as shown in FIG. 5.

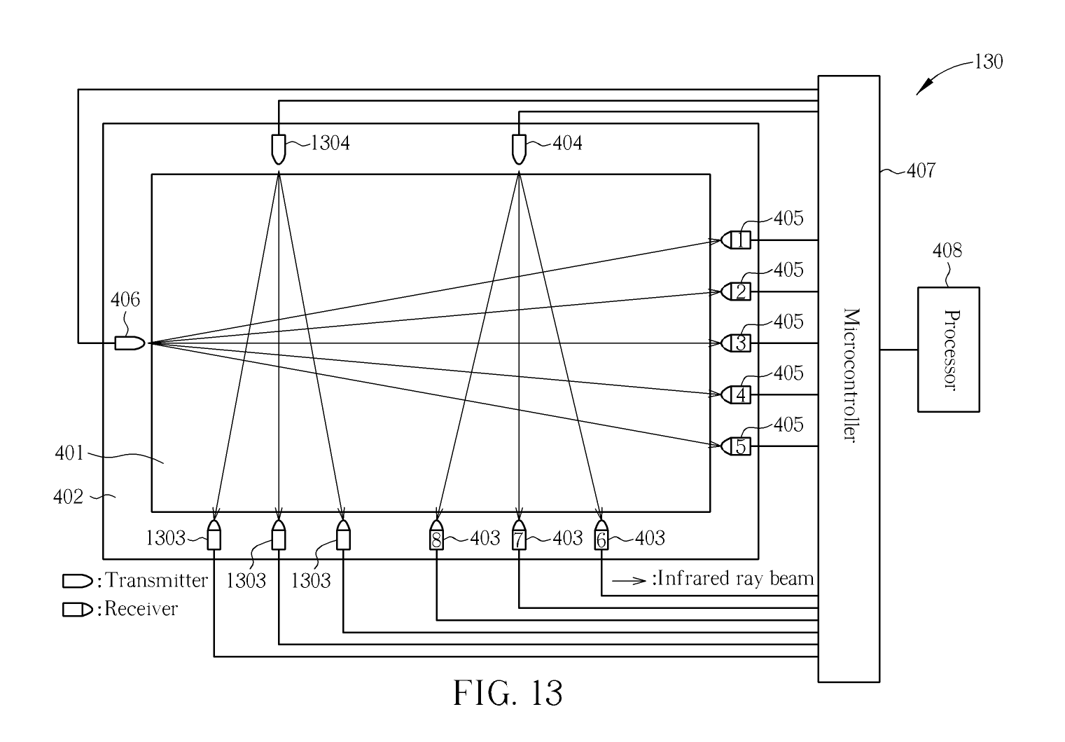

Please refer to FIG. 13. FIG. 13 is a diagram of a display panel 130 capable of IR touch functions according to a fourth embodiment of the present invention. A difference between the display panel 130 and the display panel 40 is that the display panel 130 further includes a plurality of fifth IR receivers 1303 and a fifth IR transmitter 1304. The plurality of fifth IR receivers 1303 are installed on the bottom side of the housing 402 and are electrically connected to the microcontroller 407. The fifth IR transmitter 1304 is installed on the top side of the housing 402, and transmission range of the fifth IR transmitter 1304 covers the plurality of fifth IR receivers 1303. As shown in FIG. 13, the display panel 130 has more touch points than the display panel 40. In addition, electrical connections between the microcontroller 407, the processor 408, and the plurality of fifth IR receivers 1303 are the same as shown in FIG. 5.

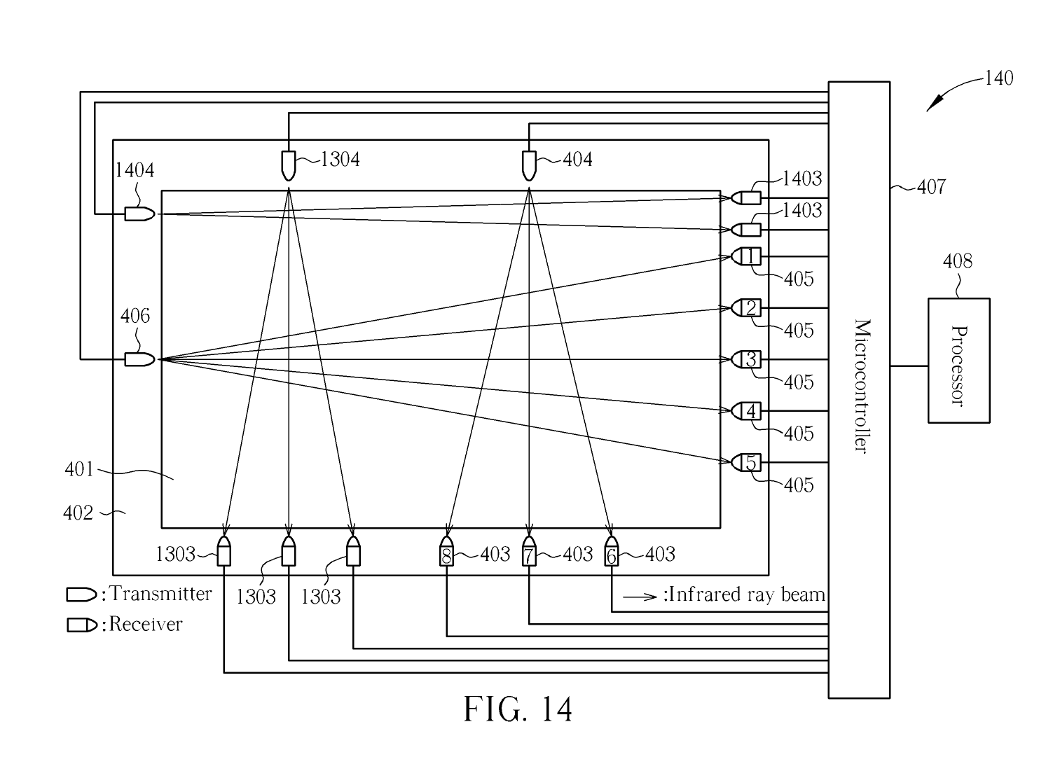

Please refer to FIG. 14. FIG. 14 is a diagram of a display panel 140 capable of IR touch functions according to a fifth embodiment of the present invention. A difference between the display panel 140 and the display panel 130 is that the display panel 140 further includes a plurality of sixth IR receivers 1403 and a sixth IR transmitter 1404. The plurality of sixth IR receivers 1403 are installed on the right side of the housing 402 and are electrically connected to the microcontroller 407. The sixth IR transmitter 1404 is installed on the left side of the housing 402, and transmission range of the sixth IR transmitter 1404 covers the plurality of sixth IR receivers 1403. As shown in FIG. 14, the display panel 140 has more touch points than the display panel 130. In addition, electrical connections between the microcontroller 407, the processor 408, and the plurality of sixth IR receivers 1403 are the same as the one in FIG. 5.

In summary, although the range of coverage of the IR touch panel in FIG. 1 is larger than the ranges of coverage of other IR touch panels, the range of coverage overlaps too much, and the cost is expensive. Matching one IR transmitter to a plurality of IR receivers in the IR touch panel, or matching a plurality of IR transmitters to one IR receiver of the IR touch panel, may be cheaper, but the range of coverage is limited. The above embodiments overcome the disadvantages of the above IR touch panels in the prior art.

Those skilled in the art will readily observe that numerous modifications and alterations of the device and method may be made while retaining the teachings of the invention.

What is claimed is:

1. An infrared (IR) ray touch panel device with high efficiency, the IR ray touch panel device comprising:
a panel;
a housing installed around the panel;
a microcontroller;
at least one first set of IR receivers installed on a bottom side of the housing, the first set of IR receivers comprising a plurality of first IR receivers;
at least one first IR transmitter installed at a top side of the housing, transmission range of the first IR transmitter covering the plurality of first IR receivers;
at least one second set IR receivers installed on a right side of the housing, the second set IR receivers comprising a plurality of second IR receivers; and
at least one second IR transmitter installed on a left side of the housing, transmission range of the second IR transmitter covering the plurality of second IR receivers;
wherein the microcontroller is electrically connected to the plurality of first IR receivers and the plurality of second IR receivers for receiving detecting signals from the plurality of first IR receivers and the plurality of second IR receivers.

2. The IR touch panel device of claim 1, further comprising:
at least one third set of IR receivers installed on the top side of the housing and electrically connected to the microcontroller, the third set of IR receivers comprising a plurality of third IR receivers; and
at least one third IR transmitter installed at a bottom side of the housing, transmission range of the third IR transmitter covering the plurality of third IR receivers.

3. The IR touch panel device of claim 2, further comprising:
at least one fourth set of IR receivers installed on the left side of the housing and electrically connected to the microcontroller, the fourth set of IR receivers comprising a plurality of fourth IR receivers; and
at least one fourth IR transmitter installed at the right side of the housing, transmission range of the fourth IR transmitter covering the plurality of fourth IR receivers.

4. The IR touch panel device of claim 1, further comprising:
at least one fifth set of IR receivers installed on a bottom side of the housing and electrically connected to the microcontroller, the fifth set of IR receivers comprising a plurality of fifth IR receivers; and
at least one fifth IR transmitter installed at the top side of the housing, transmission range of the fifth IR transmitter covering the plurality of fifth IR receivers.
